(19) United States
(12) Patent Application Publication
(10) Pub. No.: US 2013/0320784 A1
(43) Pub. Date: Dec. 5, 2013

(54) SPINDLE MOTOR

(71) Applicant: LG INNOTEK CO. LTD., Seoul (KR)

(72) Inventor: Yong Joo KIM, Seoul (KR)

(21) Appl. No.: 13/904,276

(22) Filed: May 29, 2013

(30) Foreign Application Priority Data
May 29, 2012 (KR) 10-2012-0056568

(51) Int. Cl. H02K 5/24

(52) U.S. Cl. CPC H02K 5/24
USPC 310/51

(57) ABSTRACT

A spindle motor having a turntable is disclosed, the spindle motor including a rotation shaft, a stator including a coil wound with a core arranged at a periphery of the rotation shaft, a rotor including a yoke coupled to the rotation shaft and a magnet arranged at an inner surface of the yoke, and a turn table coupled to the rotor and formed with a groove accommodating a ball, wherein a ratio (Yr/Bd) of a radius (Yr) between a center of the rotation shaft and an external surface of the yoke relative to a diameter (Bd) of the ball to reduce vibration of the rotor and the turn table is in the range of 4.6˜4.9.

### CROSS-REFERENCE TO RELATED APPLICATION

This application claims the benefit under 35 U.S.C. §119 of Korean Application No. 10-2012-0056568, filed May 29, 2012, which is hereby incorporated by reference in its entirety.

### BACKGROUND OF THE INVENTION

1. Field of the invention

The present disclosure relates to a spindle motor.

2. Description of Related Art

This section provides background information related to the present disclosure, which is not necessarily prior art.

Generally, a spindle motor serves to rotate an optical disk recorded with or recording data at a high speed.

A conventional spindle motor includes a stator, a rotation shaft rotated at a high speed relative to the stator, a rotor coupled to the rotation shaft and including a yoke and a magnet, a turn table coupled to the rotation shaft, where the turn table is formed with an automatic balancing system (ABS) reducing eccentricity in response to shapes of rotor, rotation shaft and the turn table.

The ABS is formed at a bottom surface of the turn table with a ring-shaped groove, and a ball is arranged inside the groove. The ABS is arranged at an opposite portion where eccentricity of ball is generated when the turn table is rotated at a high speed to reduce and restrict the eccentricity, whereby the rotor and the turn table are prevented from being generated with vibration.

### BRIEF SUMMARY

This section provides a general summary of the disclosure, and is not a comprehensive disclosure of its full scope or all of its features.

Exemplary aspects of the present disclosure are to substantially solve at least the above problems and/or disadvantages and to provide at least the advantages as mentioned below.

Thus, the present disclosure is directed to provide a spindle motor configured to reduce data writing error and data reading error of an optical disc fixed to a turn table by optimizing a size of a ball and a size of a yoke related to vibration and to further reduce vibration of the turn table.

The present disclosure is further directed to provide a spindle motor configured to reduce data writing error and data reading error of an optical disc fixed to a turn table by further reducing vibration of a rotor and a turn table through adjustment of a diameter of an inner surface of a groove of a turn table inserted by a ball and a diameter of an external surface of a yoke.

Technical problems to be solved by the present disclosure are not restricted to the above-mentioned, and any other technical problems not mentioned so far will be clearly appreciated from the following description by skilled in the art.

In one general aspect of the present disclosure, there is provided a spindle motor, the spindle motor comprising:

a rotation shaft;

a stator including a coil wound with a core arranged at a periphery of the rotation shaft;

a rotor including a yoke coupled to the rotation shaft and a magnet arranged at an inner surface of the yoke; and

a turn table coupled to the rotor and formed with a groove accommodating a ball, wherein a ratio (Yr/Bd) of a radius (Yr) between a center of the rotation shaft and an external surface of the yoke relative to a diameter (Bd) of the ball to reduce vibration of the rotor and the turn table is in the range of 4.6˜4.9.

In another general aspect of the present disclosure, there is provided a spindle motor, the spindle motor comprising:

a rotation shaft;

a stator including a coil wound with a core arranged at a periphery of the rotation shaft;

a rotor including a yoke coupled to the rotation shaft and a magnet arranged at an inner surface of the yoke; and

a turn table coupled to the rotor and formed with a groove accommodating a ball, wherein a radius of an inner surface at an external side contacting the ball by centrifugal force among the inner surfaces of the groove to reduce vibration caused by reduction in eccentricity of the turn table is formed smaller than a radius (Yr) of an external surface of the yoke.

In still another general aspect of the present disclosure, there is provided a spindle motor, the spindle motor comprising:

a rotation shaft;

a stator including a coil wound with a core arranged at a periphery of the rotation shaft;

a rotor including a yoke coupled to the rotation shaft and a magnet arranged at an inner surface of the yoke;

a turn table coupled to the rotor and formed with a trench-shaped groove accommodating a ball; and

a cover blocking an opening of the groove, wherein a ratio (Yr/Bd) of a radius (Yr) between a center of the rotation shaft and the external surface of the yoke relative to the diameter (Bd) of the ball to reduce vibration of the rotor and the turn table is in the range of 4.6˜4.9, and a radius of an inner surface at an external side contacting the ball by centrifugal force among the inner surfaces of the groove to reduce vibration caused by reduction in eccentricity of the turn table is formed smaller than a radius (Yr) of an external surface of the yoke.

### BRIEF DESCRIPTION OF THE DRAWINGS

The teachings of the present disclosure can be readily understood by considering the following detailed description in conjunction with the accompanying drawings, in which:

FIG. 1 is a cross-sectional view illustrating configuration of a spindle motor according to an exemplary embodiment of the present disclosure;

FIG. 2 is a graph illustrating a vibration amplitude in response to changes in size of a ball of the spindle motor of FIG. 1 and a radius at an external surface of a yoke; and

FIG. 3 is an enlarged view of ‘A’ portion of FIG. 1.

### DETAILED DESCRIPTION OF THE INVENTION

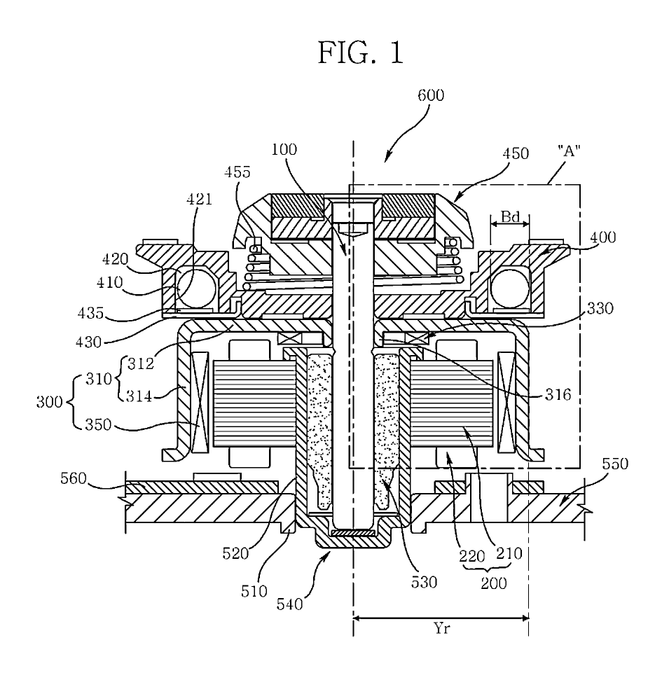

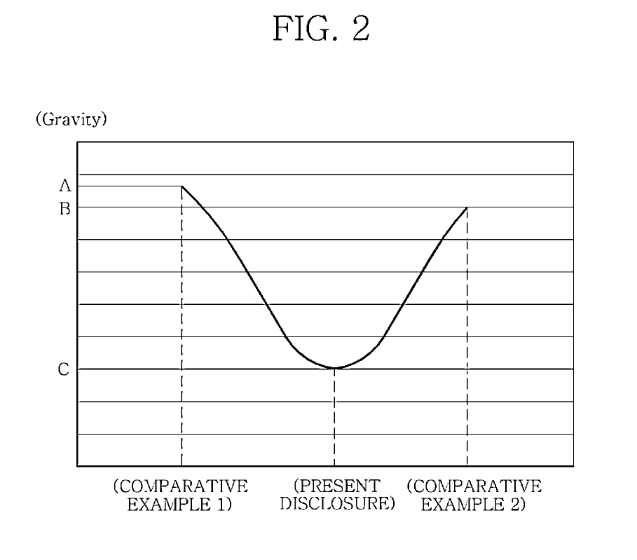

FIG. 1 is a cross-sectional view illustrating configuration of a spindle motor according to an exemplary embodiment of the present disclosure and FIG. 2 is a graph illustrating vibration amplitude in response to changes in size of a ball of the spindle motor of FIG. 1 and a radius at an external surface of a yoke.

Referring to FIGS. 1 and 2, a spindle motor 600 includes a rotation shaft 100, a stator 200, a rotor 300 and a turn table 400. In addition, the spindle motor 600 includes a bearing assembly 540, a base plate 550 and a circuit substrate 560.

The base plate 560 may include a metal plate, for example, and the base plate 550 may include a burring unit 510 coupled to the bearing assembly 540 (described later).

The circuit substrate 560 is arranged on the base plate 550, and applies a driving signal supplied from outside to the stator 200 (described later).

The bearing assembly 540 includes a bearing housing 520 and a bearing 530. The bearing housing 520 takes a shape of an upper surface-opened cylinder, for example, and may be formed by press-work of a metal plate. Alternatively, the bearing housing 520 may be formed using a brass casting process. The bearing housing 520 formed with an upper surface-opened cylinder shape includes a lateral plate and a floor plate.

An upper surface of the lateral plate at the bearing housing 520 is bent to a direction facing an external side of the lateral plate, and a portion bent to the external side of the lateral plate in the bearing housing 520 functions to press and fix a core 210 of the stator 200 (described later).

The bearing 530 is accommodated inside the bearing housing 520 and takes a shape of a cylinder formed with a rotation shaft hole. In the exemplary embodiment of the present disclosure, the bearing 530 may include an oil impregnated sintering bearing, for example. The bearing 530 is a rotational center of the rotation shaft.

The stator 200 includes a core 210 and a coil 220, and is arranged at a surrounding of the rotation shaft 100. The core 210 is formed by stacking a plurality of iron pieces each having a thin thickness, for example. The core 210 is centrally formed a through hole coupled to or press-fitted the lateral plate of the bearing housing 520.

The coil 220 is wound on core units radially protruded from the cores 210. An upper surface of the core 210 is depressed by a portion bent from the lateral surface of the bearing housing 520, whereby the core 210 is prevented from being separated from an upper surface of the lateral plate of the bearing housing 520.

The rotation shaft 100 is rotatably inserted into the rotation shaft hole of the bearing 530 accommodated into the bearing housing 520. The rotor 300 includes a yoke 310 and a magnet 350.

The yoke 310 takes a shape of a bottom-opened cylinder, and may be formed by press-work of a metal plate. To be more specific, the yoke 310 includes a yoke upper plate 312 and a yoke lateral plate 314.

The yoke upper plate takes a shape of a disc having a thin thickness, and is centrally formed with a yoke burring unit 316. The yoke burring unit 316 is coupled to or press-fitted into a periphery of the rotation shaft 100, and the yoke upper plate 312 is rotated along with the rotation shaft 100 as the yoke burring unit 316 is coupled to the rotation shaft 100.

The yoke lateral plate 314 is extended from an edge of the yoke upper plate 312 to a direction facing a bottom area, and arranged opposite to a distal end of the core 210 of the stator 200.

The magnet 350 is arranged at an inner surface of the yoke lateral plate 314, and is arranged opposite to the distal end of the core 210. The 310 and the rotation shaft 100 are rotated together by attractive force and repulsive force generated by interaction of the magnet 350 and coil 220.

The turn table 400 coupled to the rotation shaft 100 serves to support the optical disc. The turn table 400 is coupled to or press-fitted into the rotation shaft 100, and arranged at an upper surface of the yoke upper plate 312 of the yoke 310.

A bottom surface opposite to the yoke upper plate 312 of the yoke 310 in the turn table is formed with a groove 420 having a circular trench shape when viewed in a top plan view, and the groove 420 is accommodated by a ball 410, preferably a plurality of balls 410.

Meanwhile, in order to prevent the ball from being disengaged from the bottom surface of the turn table 400, the bottom surface of the turn table 400 is arranged with a cover 430 blocking an opening of the groove 420, and a felt 435 is arranged at an inner surface contacting the ball 410 in the cover 430.

A center cone 450 is inserted into the rotation shaft 100, and vertically moved relative to the rotation shaft 100. The center cone 450 fixes an inner surface of the optical disc supported at the turn table 400, and serves to align a center of the optical disc and a center of the rotation shaft 100.

Between a bottom surface of the center cone 450 vertically moving along the rotation shaft 100 and the turn table 400, there is interposed an elastic member 455 such as a coil spring elastically supporting the center cone 450, and the center cone 450 uses the elastic member 455 to vertically move the rotation shaft 100.

An inner surface of the optical disc is inserted by the center cone 450, and the optical disc is arranged at an upper surface of the turn table 400.

In the exemplary embodiment of the present disclosure, the ball 410 arranged in the groove 420 formed at the bottom surface of the turn table 400 and the yoke 310 of the rotor 300 have a great influence on vibration of the spindle motor 600.

Particularly, a diameter (Bd) of the ball 410 inserted into the groove 420 of the turn table 400 and a radius (Yr) at an external surface of the yoke lateral plate 314 of the yoke 310 have a great influence on vibration of the spindle motor 600. That is, the spindle motor 600 is generated with vibration by a ratio between the diameter (Bd) of the ball 410 inserted into the groove 420 of the turn table 400 and the radius (Yr) at the external surface of the yoke lateral plate 314, and the vibration generated from eh spindle motor 600 may generate a data reading error or a data writing error on the optical disc.

TABLE 1

| | Comparative | Comparative | Exemplary embodiment |
|---|---|---|---|
| | example 1 | example 2 | of present disclosure |
| Yr[mm] | 11.25 mm | 11.25 mm | 11.25 mm |
| Bd[mm] | 2.0 mm | 2.5 mm | 2.381 mm |
| Ratio [Yr/Bd] | 5.63 | 4.50 | 4.72 |

Yr in the Table 1 is a radius at an external surface of the yoke lateral plate 314 and Br is a diameter of the ball 410 inserted into the groove 420 of the turn table 400.

In the comparative example 1, in a case the radius Yr at an external surface of the yoke lateral plate 314 is approximately 11.25 mm and the diameter Br of the ball 410 is approximately 2.0 mm, a ratio of Yr divided by Br is approximately 5.63.

In the comparative example 2, in a case the radius Yr at an external surface of the yoke lateral plate 314 is approximately 11.25 mm and the diameter Br of the ball 410 is approximately 2.5 mm, a ratio of Yr divided by Br is approximately 5.63.

Meanwhile, in the exemplary embodiment of the present disclosure as compared with the comparative examples 1 and 2, in a case the radius Yr at an external surface of the yoke lateral plate 314 is approximately 11.25 mm and the diameter Br of the ball 410 is approximately 2.381 mm, a ratio of Yr divided by Br is approximately 4.72.

Referring to FIG. 2, as in the comparative example 1, when vibration amplitude (G, gravity) of the spindle motor was measured as “A” where the radius Yr at an external surface of the yoke lateral plate 314 is approximately 11.25 mm and the diameter Br of the ball 410 is approximately 2.0 mm.

Furthermore, as in the comparative example 2, when vibration amplitude (G) of the spindle motor was measured as “B” (B<A) where the radius Yr at an external surface of the yoke lateral plate 314 is approximately 11.25 mm and the diameter Br of the ball 410 is approximately 2.5 mm.

Referring to FIG. 2, the spindle motor in the comparative examples 1 and 2 have relatively high vibration amplitudes (G) of A and B, and as a result, a reading error or a writing error may be generated from the vibration amplitudes of the comparative examples 1 and 2 when data is read or written from the optical disc.

Meanwhile, referring to FIG. 2, the vibration amplitude (G) of the spindle motor was measured as “C” in the exemplary embodiment of the present disclosure corresponding to the comparative examples 1 and 2, where in the exemplary embodiment of the present disclosure, the radius Yr at an external surface of the yoke lateral plate 314 is approximately 11.25 mm and the diameter Br of the ball 410 is approximately 2.381 mm. The vibration amplitude “C” is smaller than the vibration amplitude “A” or “B”.

Referring to the graph in FIG. 2, in a state where the radius Yr at an external surface of the yoke lateral plate 314 is not changed, as the ratio between the radius Yr at an external surface of the yoke lateral plate 314 and the diameter Br of the ball 410 is continuously reduced from approximately 5.63 (comparative example 1) to approximately 4.72 (comparative example 2), the vibration amplitude is also continuously reduced, and the vibration amplitude was the lowest when the ratio was approximately 4.72.

Meanwhile, the vibration amplitude has continuously increased to the contrary when the ratio was reduced from approximately 4.72 (the exemplary embodiment of the present disclosure) to reach approximately 4.50 (comparative example 2), and the vibration amplitude at approximately 4.50 (comparative example 2) was great, being similar to the ratio having a vibration amplitude of approximately 5.63 (comparative example 1).

That is, in a state where the radius Yr at an external surface of the yoke lateral plate 314 is not changed, and in a case the diameter Bd of ball 410 is changed, a difference of vibration amplitude has occurred due to a difference in the diameter of the ball 410, and the vibration amplitude was relatively low when the ratio of the radius Yr at an external surface of the yoke lateral plate 314 and the diameter Bd of ball 410 was 4.72±0.1.

Particularly, in a state where the radius Yr at an external surface of the yoke lateral plate 314 is fixed at approximately 11.25 mm, and in a case size of the ball 410 was approximately 2.381 mm, and the ratio of the radius Yr at an external surface of the yoke lateral plate 314 and the diameter Bd of ball 410 was approximately 4.72, the vibration amplitude was measured the lowest.

In a case the ratio of the radius Yr at an external surface of the yoke lateral plate 314 and the diameter Bd of ball 410 was lower than approximately 4.6, the vibration amplitude has abruptly increased as shown in the graph of FIG. 2, and in a case the ratio of the radius Yr at an external surface of the yoke lateral plate 314 and the diameter Bd of ball 410 was higher than approximately 4.9, the vibration amplitude has also abruptly increased as shown in the graph of FIG. 2, such that, in the exemplary embodiment of the present disclosure, it is preferably to have the ratio of the radius Yr at an external surface of the yoke lateral plate 314 and the diameter Bd of ball 410 at approximately 4.6˜4.9, in order to prevent the disc writing error and disc reading error by reducing the vibration of the rotor 300 and the turn table 400.

Furthermore, in order to minimize the vibration of the rotor 300 and the turn table 400, it is preferable that the ratio of the radius Yr at an external surface of the yoke lateral plate 314 and the diameter Bd of ball 410 be approximately 4.72.

Still furthermore, in the exemplary embodiment of the present disclosure, in order to prevent the disc writing error and disc reading error by reducing the vibration of the rotor 300 and the turn table 400, and in a case the radius Yr at an external surface of the yoke lateral plate 314 is fixed at approximately 11.25 mm to have the ratio of the radius Yr at an external surface of the yoke lateral plate 314 and the diameter Bd of ball 410 at approximately 4.6˜4.9, it is preferable that the diameter Bd of ball 410 be approximately 2.30 mm˜2.40 mm.

Particularly, in a state where the radius Yr at an external surface of the yoke lateral plate 314 is fixed at approximately 11.25 mm, and in a case an optimal diameter Bd of ball 410 at approximately 2.381, the vibration amplitude of the spindle motor 600 can be made the smallest, whereby the data writing error and data reading error of the optical disc can be prevented.

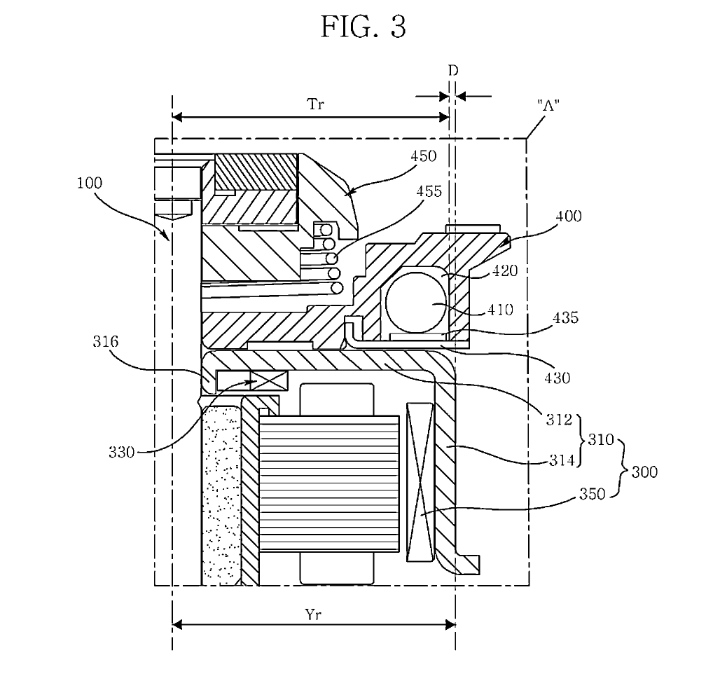

FIG. 3 is an enlarged view of ‘A’ portion of FIG. 1.

Referring to FIGS. 1 and 3, in order to reduce the vibration amplitude of the spindle motor 600, a radius Tr at an inner surface of an external side contacting the ball 410 by centrifugal force in inner surfaces of the groove 420 of the turn table 400 is formed smaller than the radius Yr at an external surface of the yoke lateral plate 314 of the yoke 310, whereby a deviation D is formed between the radius Tr at an inner surface of an external side of the groove 420 and the radius Yr at an external surface of the yoke lateral plate 314.

As noted above, in the exemplary embodiment of the present disclosure, in a case the radius Tr at an inner surface of an external side contacting the ball 410 by centrifugal force in inner surfaces of the groove 420 of the turn table 400 is formed smaller than the radius Yr at an external surface of the yoke lateral plate 314 of the yoke 310, a circumferential length of the inner surface 421 at the external side of the inner surfaces of the groove 420 can be further reduced, and the deviation caused by the shape of the groove 420 can be reduced or restricted to thereby decrease the vibration of the spindle motor 600.

Furthermore, in a case the radius Tr at an inner surface of an external side contacting the ball 410 by centrifugal force in inner surfaces of the groove 420 of the turn table 400 is smaller than the radius Yr at an external surface of the yoke lateral plate 314 of the yoke 310, the trembling of the turn table 400 can be prevented to further reduce the vibration amplitude of the turn table 400.

As apparent from the foregoing, the exemplary embodiment of the present disclosure has an advantageous effect in that the vibration amplitude of the spindle motor can be reduced to prevent the data writing error and data reading error of the optical disc by optimizing a diameter of a ball and a radius of an external surface at a yoke lateral plate of a yoke through compensation of deviation.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A spindle motor, the spindle motor comprising:
a rotation shaft;
a stator including a coil wound with a core arranged at a periphery of the rotation shaft;
a rotor including a yoke coupled to the rotation shaft and a magnet arranged at an inner surface of the yoke; and
a turn table coupled to the rotor and formed with a groove accommodating a ball, wherein a ratio (Yr/Bd) of a radius (Yr) between a center of the rotation shaft and an external surface of the yoke relative to a diameter (Bd) of the ball to reduce vibration of the rotor and the turn table is in the range of 4.6˜4.9.

2. The spindle motor of claim 1, wherein the ratio (Yr/Bd) of a radius of the external surface of the yoke relative to the diameter (Bd) of the ball is 4.72.

3. The spindle motor of claim 1, wherein the diameter (Bd) of the ball is in the range of 2.30 mm˜2.40 mm.

4. The spindle motor of claim 3, wherein the diameter (Bd) of the ball is 2.381 mm.

5. A spindle motor, the spindle motor comprising:
a rotation shaft;
a stator including a coil wound with a core arranged at a periphery of the rotation shaft;
a rotor including a yoke coupled to the rotation shaft and a magnet arranged at an inner surface of the yoke; and
a turn table coupled to the rotor and formed with a groove accommodating a ball, wherein a radius of an inner surface at an external side contacting the ball by centrifugal force among the inner surfaces of the groove to reduce vibration caused by reduction in eccentricity of the turn table is formed smaller than a radius (Yr) of an external surface of the yoke.

6. The spindle motor of claim 5, wherein the ratio (Yr/Bd) of a radius (Yr) of the external surface of the yoke relative to the diameter (Bd) of the ball to reduce vibration of the rotor and the turn table is in the range of 4.6˜4.9.

7. The spindle motor of claim 6, wherein the ratio (Yr/Bd) of a radius of the external surface of the yoke relative to the diameter (Bd) of the ball is 4.72.

8. The spindle motor of claim 6, wherein the diameter (Bd) of the ball is in the range of 2.30 mm˜2.40 mm.

9. The spindle motor of claim 6, wherein the diameter (Bd) of the ball is 2.381 mm.

10. A spindle motor, the spindle motor comprising:
a rotation shaft;
a stator including a coil wound with a core arranged at a periphery of the rotation shaft;
a rotor including a yoke coupled to the rotation shaft and a magnet arranged at an inner surface of the yoke;
a turn table coupled to the rotor and formed with a trench-shaped groove accommodating a ball; and
a cover blocking an opening of the groove,
wherein a ratio (Yr/Bd) of a radius (Yr) between a center of the rotation shaft and the external surface of the yoke relative to the diameter (Bd) of the ball to reduce vibration of the rotor and the turn table is in the range of 4.6˜4.9, and a radius of an inner surface at an external side contacting the ball by centrifugal force among the inner surfaces of the groove to reduce vibration caused by reduction in eccentricity of the turn table is formed smaller than a radius (Yr) of an external surface of the yoke.

11. The spindle motor of claim 10, wherein the ratio (Yr/Bd) of a radius of the external surface of the yoke relative to the diameter (Bd) of the ball is 4.72.

12. The spindle motor of claim 10, wherein the diameter (Bd) of the ball is in the range of 2.30 mm˜2.40 mm.

13. The spindle motor of claim 10, wherein the diameter (Bd) of the ball is 2.381 mm.
